(19) United States
(12) Patent Application Publication
(10) Pub. No.: US 2015/0024134 A1
(43) Pub. Date: Jan. 22, 2015

(54) IMAGE RECORDING METHOD

(71) Applicant: CANON KABUSHIKI KAISHA, Tokyo (JP)

(72) Inventors: Katsuhiro Hayashi, Yokohama-shi (JP); Ikuo Nakazawa, Kawasaki-shi (JP); Eri Watanabe, Fukaya-shi (JP)

(21) Appl. No.: 14/320,704

(22) Filed: Jul. 1, 2014

(30) Foreign Application Priority Data
Jul. 18, 2013 (JP) 2013-149367

(51) Int. Cl. C09D 11/30; B05D 3/10; C09D 11/107; B05D 1/02

(52) U.S. Cl. CPC C09D 11/30; B05D 1/02; B05D 3/107; C09D 11/107; C08L 2205/03
USPC 427/258

(57) ABSTRACT

An image recording method including applying an ink onto a recording medium; and applying a liquid composition that destabilizes a dispersion state of a pigment in the ink onto the recording medium so as to at least partially overlap with a region in which the ink is applied. The ink contains the pigment, a first soluble polymer, a second soluble polymer, polymer particles, and water. The first water-soluble polymer has a weight-average molecular weight of 1,000-4,000 and has an acid value of 150-300 mgKOH/g. The second water-soluble polymer has an aromatic group and has a weight-average molecular weight of 5,000-30,000 and an acid value of 50-150 mgKOH/g. The polymer particles have a rate of change in volume-average particle size of 20% or less between a pH of 7 and a pH of 9.

### BACKGROUND OF THE INVENTION

1. Field of the Invention

The present invention relates to an image recording method.

2. Description of the Related Art

In general, a pigment alone is poorly dispersible in a dispersion medium. Accordingly, many studies have been made heretofore for the purpose of obtaining a stable pigment dispersion. For example, dispersion stability of the pigment in various dispersion media has been improved by using a polymer or a surfactant as a dispersant. For example, Japanese Patent Application Laid-Open No. 2003-292838 (Patent Literature 1), Japanese Patent Application Laid-Open No. 2004-115708 (Patent Literature 2), Japanese Patent Application Laid-Open No. 2001-234097 (Patent Literature 3) and Japanese Patent Translation Publication No. 2011-508806 (Patent Literature 4) propose incorporation of two kinds of polymers into a pigment ink in order to improve the dispersion stability of the pigment.

In addition, various studies have been made heretofore for the purpose of recording an image having high fixability onto a recording medium and satisfactory image quality with a pigment ink. For example, Japanese Patent Application Laid-Open No. 2007-99913 (Patent Literature 5) and Japanese Patent Application Laid-Open No. 2008-195767 (Patent Literature 6) propose incorporation of an emulsion into the pigment ink.

In recent years, for the purpose of recording an image having a higher level of image quality, studies have been made on an image recording method based on a two-component reaction system, the method involving using a pigment ink and a liquid composition containing a reactant that destabilizes a dispersion state of the pigment in the ink. In the image recording method based on the two-component reaction system, an image is recorded by bringing the liquid composition containing the reactant and the pigment ink into contact with each other on a recording medium to aggregate the pigment in the ink. This image recording method has been used not only for printing onto a permeable recording medium such as paper, but also for printing onto a poorly-permeable recording medium such as coated paper, and for printing onto a non-permeable recording medium that uses a plastic material such as polyvinyl chloride or polyethylene terephthalate.

As an example of a set to be used in the image recording method based on the two-component reaction system, Japanese Patent Application Laid-Open No. 2010-31267 (Patent Literature 7) discloses a set of an ink containing a polymer-dispersed pigment-and-a liquid composition containing an organic acid.

### SUMMARY OF THE INVENTION

According to the present invention, there is provided an image recording method including applying an ink onto a recording medium; and applying a liquid composition that destabilizes a dispersion state of a pigment in the ink onto the recording medium so as to at least partially overlap with a region in which the ink is applied, in which the ink includes the pigment, a first water-soluble polymer, a second water-soluble polymer, polymer particles, and water; the first water-soluble polymer has a weight-average molecular weight of 1,000 or more and 4,000 or less and has an acid value of 150 mgKOH/g or more and 300 mgKOH/g or less; the second water-soluble polymer has an aromatic group and has a weight-average molecular weight of 5,000 or more and 30,000 or less and an acid value of 50 mgKOH/g or more and 150 mgKOH/g or less; and the polymer particles satisfy the following relationship:

(PS_{pH9}−PS_{pH7})/PS_{pH7}×100≦20%

where PS_{pH9} is a volume-average particle size of the polymer particles at a pH of 9, and PS_{pH7} is a volume-average particle size of the polymer particles at a pH of 7.

According to one embodiment of the present invention, the image recording method by which a uniform and distortion-free image can be recorded even onto a poorly-permeable or non-permeable recording medium can be provided.

Further features of the present invention will become apparent from the following description of exemplary embodiments.

### DESCRIPTION OF THE EMBODIMENTS

Preferred embodiments of the present invention will now be described in detail.

Even by the method described in Patent Literatures 1 to 7 or the like, it is difficult to record a uniform and distortion-free image onto a recording medium that hardly absorbs ink such as coated paper. For example, with the pigment ink proposed in Patent Literatures 1 to 6 or the like, which is intended for use in image recording onto an ink-absorbing recording medium, it is difficult to record an image onto a poorly-permeable recording medium that hardly absorbs ink, such as coated paper. Further, even when the pigment ink proposed in Patent Literatures 1 to 6 or the like is used for a set in combination with a liquid composition that destabilizes the dispersion state of the pigment in the ink, it is difficult to record a uniform and distortion-free image onto a poorly-permeable or non-permeable recording medium. The reasons for this are considered as described below.

The ink described in Patent Literatures 1 and 2 contains a high-molecular-weight added polymer. When such ink is brought into contact with the liquid composition, not only the pigment but also the added polymer aggregates. The high-molecular-weight added polymer whose state is changed from a dissolved state to an aggregated state undergoes a large change in volume, and thus causes a large flow in the mixed liquid of the ink and the liquid composition. As a result, the aggregated pigment is localized, which causes distortion on an image.

In addition, the dispersing polymer contained in the ink described in Patent Literatures 3 to 7 disperses and stabilizes the pigment through the adsorption of part of the dispersing polymer onto the pigment based on adsorption equilibrium. Accordingly, unless measures are taken to suppress the desorption of the dispersing polymer, the dispersing polymer that has been isolated is present in the ink. In addition, the isolated high-molecular-weight dispersing polymer undergoes a large change in volume by contact with the liquid composition, and thus causes distortion on an image as described above.

Therefore, an object of the present invention is to provide an image recording method by which a uniform and distortion-free image can be recorded even onto a poorly-permeable or non-permeable recording medium.

Hereinafter, the present invention is described in detail by way of exemplary embodiments. The inventors of the present invention have first made studies on conditions for preventing the occurrence of distortion on an image. As a result, the inventors have found that it is important to suppress, when an ink and liquid composition constituting a two-component reaction system are brought into contact with each other, a flow that is caused in a mixed liquid thereof. Then, the inventors have reached the conclusion that it is important to satisfy the following conditions (1) and (2) in order to suppress such flow.

(1) The constituent components of the ink hardly change in occupied volume during reaction.
(2) Particles for dissipating the flow are present.

In order to satisfy the condition (1) in a two-component reaction system using a pigment ink, it is effective to reduce the amount of a high-molecular-weight polymer present in a dissolved state in the solvent of the ink as much as possible. In addition, in order to satisfy the condition (2), it is effective to blend a dispersion of polymer particles, such as an emulsion, in the ink in addition to pigment particles. Further, it is effective that such polymer particles themselves satisfy the condition (1). Based on the above-mentioned findings, the inventors of the present invention have made further studies, and as a result, have found the configuration of the image recording method of the present invention described above. The mechanism by which the adoption of such configuration enables the recording of a distortion-free image having a high level of image quality is presumably as described below.

A first water-soluble polymer needs to have an acid value of 150 mgKOH/g or more and 300 mgKOH/g or less in order to be stably present in the ink. In addition, a second water-soluble polymer needs to contain a constituent unit derived from a monomer having an aromatic group, which can serve as a hydrophobic segment having a high affinity for the pigment, in order to function as a pigment dispersant. Further, the second water-soluble polymer needs to have an acid value of 50 mgKOH/g or more and 150 mgKOH/g or less, in order to secure the affinity of the ink for a solvent.

When the acid value of the first water-soluble polymer is less than 150 mgKOH/g, its hydrophobicity increases to increase the degree of adsorption onto the pigment. In addition, the first water-soluble polymer has a lower molecular weight than that of the second water-soluble polymer, and hence has a higher molecular mobility (that is, a higher rate of adsorption onto the pigment), consequently inhibiting the adsorption of the second water-soluble polymer onto the pigment. As a result, the higher-molecular-weight second water-soluble polymer is liable to be isolated, a volume change caused by contact with a liquid composition becomes large, and distortion is liable to be caused on an image to be recorded. On the other hand, when the acid value of the first water-soluble polymer is more than 300 mgKOH/g, the hydrophilicity of the first water-soluble polymer is kept even after contact with the liquid composition. Accordingly, a hydrophilic spot is generated on an image and is separated from a hydrophobic pigment aggregate whose dispersion state has been destabilized, causing a distortion-like gap in an image to be recorded.

In addition, the first water-soluble polymer and the second water-soluble polymer play roles in satisfying the condition (1). When only the second water-soluble polymer is used as the dispersing polymer, part of the second water-soluble polymer is isolated in a dissolved state in the ink based on adsorption equilibrium. However, when the first water-soluble polymer having higher solubility than that of the second water-soluble polymer is also present in the ink, the adsorption equilibrium of the second water-soluble polymer is shifted toward adsorption onto the pigment, resulting in a state in which the isolation is suppressed to the utmost. In addition, the first water-soluble polymer present in a dissolved state in the ink has a molecular weight within such a range that a volume change is hardly caused even by contact with the liquid composition. Accordingly, the first water-soluble polymer is unlikely to be a cause of the occurrence of distortion on an image. That is, the first water-soluble polymer needs to have a lower molecular weight and comparable or higher solubility in the ink than that of the second water-soluble polymer.

When the weight-average molecular weight of the first water-soluble polymer is less than 1,000, the molecular motion of the first water-soluble polymer is large, which increases wettability with, for example, a member to be brought into contact with the ink. Accordingly, the ejection property of the ink is reduced, which causes a distortion-like gap in an image to be recorded. On the other hand, when the weight-average molecular weight of the first water-soluble polymer is more than 4,000, the volume change of the first water-soluble polymer to be caused upon contact with the liquid composition becomes large, which causes distortion on an image to be recorded.

When the weight-average molecular weight of the second water-soluble polymer is less than 5,000, the molecular mobility of the second water-soluble polymer becomes higher, which increases the rate of desorption from the pigment. As a result, the volume change caused by contact with the liquid composition becomes large, which is liable to cause distortion on an image to be recorded. On the other hand, when the weight-average molecular weight of the second water-soluble polymer is more than 30,000, the second water-soluble polymer functions as a crosslinking agent between pigment particles in the ink. As a result, the ejection property of the ink is reduced, which causes a distortion-like gap in an image to be recorded.

Further, the pigment and polymer particles dispersed by the second water-soluble polymer play roles in satisfying the condition (2). By virtue of the presence of the particles such as the pigment and polymer particles in the ink, a flow to be caused in the mixed liquid of the ink and the liquid composition is dissipated, and the localization of the pigment is suppressed. In addition, when the polymer particles themselves satisfy the condition (1), the occurrence of distortion on an image to be recorded can be effectively suppressed.

The polymer particles need to have a rate of change in volume-average particle size of 20% or less during a process in which the environment changes from an ink environment having a pH of about 9 to a mixed liquid environment having a pH of 7 or less generated by contact with the liquid composition. In other words, the polymer particles satisfy the following relationship:

(PS_{pH9}−PS_{pH7})/PS_{pH7}×100≦20%

where PS_{pH9} is a volume-average particle size of the polymer particles at a pH of 9, and PS_{pH7} is a volume-average particle size of the polymer particles at a pH of 7. When the rate of change in volume-average particle size of the polymer particles between a pH of 7 and a pH of 9 is more than 20%, a flow to be caused in the mixed liquid of the ink and the liquid composition enlarges in association with the volume change of the polymer particles. Accordingly, the pigment is liable to be localized, which is liable to cause distortion on an image to be recorded. The inventors of the present invention assume that synergetic functioning of the respective configurations of the image recording method of the present invention by the mechanism described above enables the achievement of the effect of the present invention.

<Image Recording Method>

The image recording method of the present invention includes the steps of applying an ink onto a recording medium; and applying a liquid composition that destabilizes a dispersion state of a pigment in the ink onto the recording medium so as to at least partially overlap with a region in which the ink is applied.

Various hitherto known techniques may be appropriately adopted as a method of applying the ink onto the recording medium and a method of applying the liquid composition to the ink. Specific examples thereof may include methods involving using die coating, blade coating, a gravure roller, and a combination thereof with an offset roller. In addition, as a technique capable of applying the ink or the liquid composition at a high speed with high accuracy, a method involving using an ink jet device is extremely suitable.

In the image recording method of the present invention, a set including an ink and a liquid composition is preferably used. It should be noted that the set encompasses the case of using multiple individual liquid cartridges in combination as well as a liquid cartridge unit in which multiple liquid cartridges are integrated. Further, an integrated combination of a liquid cartridge and a recording head is also encompassed.

<Ink>

The ink to be used in the image recording method of the present invention contains a pigment, a first water-soluble polymer, a second water-soluble polymer, polymer particles, and water. Each of the components constituting the ink is described below.

Pigment

Examples of the pigment may include inorganic pigments such as carbon black, and organic pigments. It should be noted that any of the known pigments that can be used for ink may be used as the pigment. The content (mass %) of the pigment in the ink is generally 0.1 mass % or more and 15.0 mass % or less, preferably 1.0 mass % or more and 10.0 mass % or less with reference to the total mass of the ink. It should be noted that the pigment is dispersed in the ink by the second water-soluble polymer, which functions as a dispersing polymer.

First Water-Soluble Polymer

A polymer having a weight-average molecular weight of 1,000 or more and 4,000 or less and an acid value of 150 mgKOH/g or more and 300 mgKOH/g or less is used as the first water-soluble polymer. As long as the polymer satisfies those conditions, the kinds and ratios of its constituent monomers and the like are not particularly limited. It should be noted that the term “water-soluble polymer” as used herein means a polymer that has a solubility in water at 25° C. of 0.1 g/L or more under a state in which part or all of the acid groups in the polymer have been neutralized with a base. In addition, the term “weight-average molecular weight” as used herein refers to a value in terms of polystyrene measured by gel permeation chromatography (GPC).

The first water-soluble polymer may be obtained by, for example, polymerizing a monomer component including an acid monomer having an α,β-ethylenically unsaturated double bond. Any of the known acid monomers may be used as such acid monomer. Of those, from the viewpoint that the volume change at the time of contact with the liquid composition is hardly caused, at least one of acrylic acid and methacrylic acid is preferred. That is, the first water-soluble polymer preferably contains a constituent unit derived from at least one of acrylic acid and methacrylic acid. It should be noted that any other monomer except the acid monomer may be used as a monomer component. Any of the known monomers may be used as the other monomer.

The first water-soluble polymer may be produced by polymerizing monomer components including the acid monomer and the other monomer in the presence of a polymerization initiator and the like in an organic solvent such as methyl ethyl ketone. Any of the known polymerization initiators such as an azo compound initiator, an organic peroxide initiator, and a redox initiator may be used as the polymerization initiator. The obtained first water-soluble polymer is generally subjected to the neutralization of part or all of its acid groups with a base before being used for the ink.

Second Water-Soluble Polymer

A polymer having an aromatic group and having a weight-average molecular weight of 5,000 or more and 30,000 or less and an acid value of 50 mgKOH/g or more and 150 mgKOH/g or less is used as the second water-soluble polymer. As long as the polymer satisfies those conditions, the kinds and ratios of its constituent monomers, and the like are not particularly limited.

The second water-soluble polymer may be obtained by, for example, polymerizing monomer components including an aromatic monomer having an α,β-ethylenically unsaturated double bond and an acid monomer having an α,β-ethylenically unsaturated double bond. Any of the known aromatic monomers may be used as such aromatic monomer. Of those, from the viewpoint of further shifting the adsorption equilibrium of the second water-soluble polymer toward the pigment side, the aromatic monomer is preferably at least any one selected from the group consisting of styrene, benzyl acrylate, and benzyl methacrylate. That is, the second water-soluble polymer preferably contains a constituent unit derived from at least one of styrene, benzyl acrylate, and benzyl methacrylate.

In addition, any of the known acid monomers may be used as the acid monomer. Of those, from the viewpoint of improving the dispersion stability of the pigment, at least one of acrylic acid and methacrylic acid is preferred. That is, the second water-soluble polymer preferably contains a constituent unit derived from at least one of acrylic acid and methacrylic acid. It should be noted that any other monomer except the aromatic monomer and the acid monomer may be used as a monomer component. Any of the known monomers may be used as the other monomer.

The second water-soluble polymer may be produced in a similar manner to that of the first water-soluble polymer described above. In addition, the obtained second water-soluble polymer is generally subjected to the neutralization of part or all of its acid groups with a base before being used for the ink.

Ratio Between Pigment and First Water-Soluble Polymer

The content (mass %) of the first water-soluble polymer in the ink is preferably 1% or more and 15% or less in terms of mass ratio with respect to the content (mass %) of the pigment. When the content of the first water-soluble polymer is less than 1% in terms of mass ratio with respect to the content of the pigment, the shifting effect on the adsorption equilibrium of the second water-soluble polymer toward adsorption onto the pigment is difficult to obtain, resulting in insufficiency of the suppressive effect on distortion on an image in some cases. In addition, the first water-soluble polymer undergoes little volume change even when brought into contact with the liquid composition, and hence does not affect an image when its content is 15% or less in terms of mass ratio with respect to the content of the pigment. On the other hand, when the content of the first water-soluble polymer is more than 15% in terms of mass ratio with respect to the content of the pigment, accumulation of slight volume changes may cause fine distortion on an image.

Quantitative Ratio Between First Water-Soluble Polymer and Second Water-Soluble Polymer

The content of the second water-soluble polymer in the ink is preferably higher than the content of the first water-soluble polymer. When the content of the second water-soluble polymer is equal to or lower than the content of the first water-soluble polymer, the shifting effect on the adsorption equilibrium of the second water-soluble polymer toward adsorption onto the pigment is difficult to obtain, resulting in insufficiency of the suppressive effect on distortion on an image in some cases.

Polymer Particles

The polymer particles to be incorporated into the ink have a rate of change in volume-average particle size of 20% or less between a pH of 7 and a pH of 9. This condition is expressed by the following relationship:

(PS_{pH9}−PS_{pH7})/PS_{pH7}×100≦20%

where PS_{pH9} is a volume-average particle size of the polymer particles at a pH of 9, and PS_{pH7} is a volume-average particle size of the polymer particles at a pH of 7. As long as the polymer particles satisfy that condition, the kinds and ratios of monomers constituting the polymer, and the like are not particularly limited. It should be noted that the volume-average particle size of the polymer particles at a pH of 7 is preferably 20 nm or more and 1 μm or less, more preferably 50 nm or more and 500 nm or less.

The polymer particles are used, for example, in an emulsion state including the polymer particles and a dispersion medium for dispersing the polymer particles. Any of the known polymers may be used as a polymer for forming the polymer particles. Of those, from the viewpoint of the ejection property of the ink, an acrylic polymer or a styrene-acrylic polymer is preferred. When any other polymer is used, the ejection property of the ink may reduce, which may be liable to cause a distortion-like gap in an image to be recorded. Further, from the viewpoint that the volume change at the time of contact with the liquid composition is hardly caused, a polymer containing a constituent unit derived from at least one kind selected from the group consisting of styrene, (meth)acrylic acid, and a (meth)acrylic acid ester is preferred. In addition, the polymer for forming the polymer particles preferably has an acid value of 50 mgKOH/g or less. When the acid value of the polymer for forming the polymer particles is more than 50 mgKOH/g, the volume change at the time of contact with the liquid composition becomes large, resulting in insufficiency of the suppressive effect on distortion on an image in some cases.

Ratio Between Pigment and Polymer Particles

The content (mass %) of the polymer particles in the ink is preferably 50% or more and 500% or less in terms of mass ratio with respect to the content (mass %) of the pigment. When the content of the polymer particles is less than 50% in terms of mass ratio with respect to the content of the pigment, the suppressive effect on the flow to be caused in the mixed liquid upon contact between the ink and the liquid composition is small, resulting in insufficiency of the suppressive effect on distortion on an image in some cases. On the other hand, when the content of the polymer particles is more than 500% in terms of mass ratio with respect to the content of the pigment, coloring power in a portion of the image where the polymer particles are continuously present is weak, with the result that the portion may be visually recognized as distortion.

Aqueous Medium

The ink may use water, or an aqueous medium that is a mixed solvent of water and a water-soluble organic solvent. The content (mass %) of the water-soluble organic solvent in the ink is preferably 3.0 mass % or more and 50.0 mass % or less with reference to the total mass of the ink. Any of those hitherto generally used for ink may be used as the water-soluble organic solvent. Examples thereof may include alcohols, glycols, alkylene glycols having an alkylene group having 2 to 6 carbon atoms, polyethylene glycols, nitrogen-containing compounds, and sulfur-containing compounds. One kind of those water-soluble organic solvents may be used alone, or two or more kinds thereof may be used in combination. Deionized water (ion-exchanged water) is preferably used as the water. The content (mass %) of the water in the ink is preferably 50.0 mass % or more and 95.0 mass % or less with reference to the total mass of the ink.

Other Components

As required, the ink may contain, in addition to the above-mentioned components, a water-soluble organic compound that is solid at ordinary temperature such as a polyhydric alcohol such as trimethylolpropane or trimethylolethane; or urea or a urea derivative such as ethylene urea. Further, as required, the ink may contain various additives such as a surfactant, a pH adjustor, a rust inhibitor, an antiseptic, an antifungal agent, an antioxidant, an anti-reducing agent, an evaporation accelerator, and a chelator.

<Liquid Composition>

The liquid composition to be used in the image recording method of the present invention destabilizes the dispersion state of the pigment in the ink. In the present invention, whether or not the liquid composition “destabilizes the dispersion state of the pigment in the ink” can be determined according to the following method. First, the ink is added dropwise into a 10-fold amount by mass of the liquid composition, followed by stirring for 30 minutes. Next, the particle size of the pigment is measured using a laser diffraction/scattering particle size distribution analyzer (trade name: “LA-950V2”, manufactured by HORIBA, Ltd.) under the conditions of a refractive index of a sample of 1.5, a refractive index of a dispersion medium (water) of 1.333, and a repetition number of 15. When the pigment is found to have a volume-based median size of 1 μm or more as a result of the measurement, it is determined that the liquid composition “destabilizes the dispersion state of the pigment in the ink.”

In addition, in order for the liquid composition not to affect an image recorded with the ink, the liquid composition is preferably colorless, milky white, or white. For that purpose, the ratio between the maximum absorbance and minimum absorbance (maximum absorbance/minimum absorbance) of the liquid composition in a wavelength region of from 400 to 800 nm, which is the wavelength region of visible light, is preferably 1.0 or more and 2.0 or less. This means that the liquid composition has substantially no absorbance peak in the wavelength region of visible light, or that even if the liquid composition has a peak, the intensity of the peak is extremely small. Further, the liquid composition is preferably a clear ink that contains no coloring material. In Examples to be described later, the absorbance of the liquid composition was measured using an undiluted liquid composition as a measurement sample, and using a spectrophotometer (trade name: “Hitachi Double-Beam Spectrophotometer U-2900,” manufactured by Hitachi High-Technologies Corporation). It should be noted that the absorbance may be measured using a diluted liquid composition as a measurement sample. This is because both the maximum absorbance and minimum absorbance of the liquid composition are inversely proportional to the dilution factor, and hence the ratio between the maximum absorbance and the minimum absorbance (maximum absorbance/minimum absorbance) does not depend on the dilution factor.

Reactant

The liquid composition contains a reactant having, for example, an action of destabilizing the dispersion state of the pigment in the ink. Examples of such reactant may include an organic acid, a polyvalent metal ion, and a cationic compound. Of those, an organic acid is preferred because the organic acid hardly moves with respect to the flow of an aggregate containing the pigment during the process of aggregation. That is, the liquid composition preferably contains an organic acid.

Specific examples of the organic acid may include glutaric acid, succinic acid, levulinic acid, methanesulfonic acid, citric acid, ascorbic acid, malic acid, aspartic acid, glutamic acid, pyruvic acid, N-(2-acetamido)iminodiacetic acid, bis(2-hydroxyethyl)iminotris(hydroxymethyl)methane, and 2-morpholinoethanesulfonic acid.

A di- or higher valent metal ion may suitably be used as the polyvalent metal ion. Examples of the divalent metal ion may include ions of alkali earth metals such as beryllium, magnesium, calcium, strontium, barium, and radium. In addition, examples of the tri- or higher valent metal ion may include ions of aluminum, yttrium, zirconium, and iron as well as other transition metals. It should be noted that the polyvalent metal ion may be added to the liquid composition in a form of a salt such as a hydroxide, a chloride, a nitrate, or a sulfate.

It should be noted that specific examples of the cationic compound may include polyallylamine, a vinylpyrrolidone-N,N-dimethylaminoethyl methacrylate copolymer sulfuric acid salt, ethyleneimine, an epichlorohydrin-dimethylamine polymerized product, dimethyldiallylammonium chloride, dicyandiamide-diethylenetriamine ammonium chloride, and guanidinoformamide.

Aqueous Medium and Other Components

The liquid composition may use water, or an aqueous medium that is a mixed solvent of water and a water-soluble organic solvent. The content (mass %) of the water-soluble organic solvent in the liquid composition is preferably 3.0 mass % or more and 80.0 mass % or less with reference to the total mass of the liquid composition. Similar water-soluble organic solvents to those mentioned as usable for the ink may be used as the water-soluble organic solvent. Deionized water (ion-exchanged water) is preferably used as the water. The content (mass %) of the water in the liquid composition is preferably 1.0 mass % or more and 80.0 mass % or less with reference to the total mass of the liquid composition. In addition, the liquid composition may use other components similar to those mentioned as usable for the ink.

### EXAMPLES

Hereinafter, the present invention is described in more detail by way of Examples and Comparative Examples. However, the present invention is by no means limited to Examples below, and various modifications are possible without departing from the gist of the present invention. It should be noted that in the description of Examples below, “part(s)” and “%” are by mass unless otherwise specified.

Preparation of First Water-Soluble Polymers A1 to A15

A flask equipped with a stirrer, a nitrogen inlet tube, a reflux condenser, and a thermometer was loaded with 200 parts of methyl ethyl ketone, followed by heating to 80° C. under a nitrogen atmosphere while stirring. After that, a mixed liquid of monomers and chain transfer agent whose kinds and amounts were shown in Tables 1-1 and 1-2, and a mixed liquid of 1 part of a polymerization initiator (trade name: “V-59”, manufactured by Wako Pure Chemical Industries, Ltd.) and 10 parts of methyl ethyl ketone were each added dropwise over 2 hours while the temperature was maintained at 80° C. After the dropwise addition, while the temperature was further maintained at 80° C., the mixture was stirred for 4 hours to obtain first water-soluble polymers A1 to A15. Tables 1-1 and 1-2 show the weight-average molecular weights and acid values of the obtained first water-soluble polymers A1 to A15. It should be noted that the obtained first water-soluble polymers A1 to A14 were each turned to a 25% aqueous solution by adding 0.9 equivalent of potassium hydroxide with respect to the acid value, and an appropriate amount of ion-exchanged water, and then removing methyl ethyl ketone under reduced pressure. It should be noted that A15 was not able to be dissolved in water.

TABLE 1-1

| First water-soluble | | | | | | | | | | | |
|---|---|---|---|---|---|---|---|---|---|---|---|
| polymer | | A1 | A2 | A3 | A4 | A5 | A6 | A7 | A8 | A9 | A10 |
| Monomer | MMA | 69 | 50 | 69 | 69 | 77 | 54 | 77 | 18 | | 39 |
| (parts) | BzMA | | 19 | | | | | | | | |
| | St | | | | | | | | | | 30 |
| | MA | | | | | | | | | 69 | |
| | MAA | 31 | 31 | 31 | 31 | 23 | 46 | 23 | | 31 | 31 |
| | SA | | | | | | | | 82 | | |
| Chain transfer | Mercapto- | 4.0 | 4.0 | 7.5 | 2.0 | 4.0 | 4.0 | 2.0 | 4.0 | 4.0 | 4.0 |
| agent (parts) | ethanol | | | | | | | | | | |

| | | | | | | | | | | |
|---|---|---|---|---|---|---|---|---|---|---|
| Weight-average molecular | 2,000 | 2,000 | 1,000 | 4,000 | 2,000 | 2,000 | 4,000 | 2,000 | 2,000 | 2,000 |
| weight | | | | | | | | | | |
| Acid value (mgKOH/g) | 202 | 202 | 202 | 202 | 150 | 300 | 150 | 200 | 202 | 202 |

MMA: methyl methacrylate
BzMA: benzyl methacrylate
St: styrene
MA: methyl acrylate
MAA: methacrylic acid
SA: 2-methacryloyloxyethyl succinate (manufactured by Shin-Nakamura Chemical Co., Ltd.)

TABLE 1-2

| First water-soluble polymer | | A11 | A12 | A13 | A14 | A15 |
|---|---|---|---|---|---|---|
| Monomer (parts) | MMA | 69 | 69 | 78 | 53 | 100 |
| | BzMA | | | | | |
| | St | | | | | |
| | MA | | | | | |
| | MAA | 31 | 31 | 22 | 47 | |
| | SA | | | | | |
| Chain transfer | Mercapto- | 9.0 | 1.8 | 4.0 | 4.0 | 4.0 |
| agent (parts) | ethanol | | | | | |

| | | | | | |
|---|---|---|---|---|---|
| Weight-average molecular weight | 900 | 4,300 | 2,000 | 2,000 | 2,000 |
| Acid value (mgKOH/g) | 202 | 202 | 145 | 305 | 0 |

MMA: methyl methacrylate
BzMA: benzyl methacrylate
St: styrene
MA: methyl acrylate
MAA: methacrylic acid
SA: 2-methacryloyloxyethyl succinate (manufactured by Shin-Nakamura Chemical Co., Ltd.)

Preparation of Second Water-Soluble Polymers B1 to B16

A flask equipped with a stirrer, a nitrogen inlet tube, a reflux condenser, and a thermometer was loaded with 200 parts of methyl ethyl ketone, followed by heating to 80° C. under a nitrogen atmosphere while stirring. After that, a mixed liquid of monomers whose kinds and amounts were shown in Tables 2-1 and 2-2, and a mixed liquid of a polymerization initiator (trade name: “V-59”, manufactured by Wako Pure Chemical Industries, Ltd.) whose amount was shown in Tables 2-1 and 2-2, and 10 parts of methyl ethyl ketone were each added dropwise over 2 hours while the temperature was maintained at 80° C. After the dropwise addition, while the temperature was further maintained at 80° C., the mixture was stirred for 4 hours to obtain second water-soluble polymers B1 to B16. Tables 2-1 and 2-2 show the weight-average molecular weights and acid values of the obtained second water-soluble polymers B1 to B16. It should be noted that the obtained second water-soluble polymers B1 to B15 were each turned to a 25% aqueous solution by adding 0.9 equivalent of potassium hydroxide with respect to the acid value, and an appropriate amount of ion-exchanged water, and then removing methyl ethyl ketone under reduced pressure. It should be noted that B16 was not able to be dissolved in water.

TABLE 2-1

| Second water-soluble | | | | | | | | | | | |
|---|---|---|---|---|---|---|---|---|---|---|---|
| polymer | | B1 | B2 | B3 | B4 | B5 | B6 | B7 | B8 | B9 | B10 |
| Monomer | St | 35 | 35 | 35 | 35 | 35 | 35 | 35 | | | |
| (parts) | BzA | | | | | | | | 35 | | |
| | BzMA | | | | | | | | | 35 | |
| | PhEA | | | | | | | | | | 35 |
| | nBA | 52 | 52 | 52 | 58 | 46 | 46 | 26 | 52 | 52 | 52 |
| | AA | 13 | 13 | 13 | 7 | 19 | 19 | | 13 | 13 | 13 |
| | A-SA | | | | | | | 39 | | | |
| Polymerization | V-59 | 1.5 | 3.8 | 0.7 | 1.5 | 1.5 | 3.8 | 1.5 | 1.5 | 1.5 | 1.5 |
| initiator | | | | | | | | | | | |
| (part(s)) | | | | | | | | | | | |

| | | | | | | | | | | |
|---|---|---|---|---|---|---|---|---|---|---|
| Weight-average | 12,800 | 5,000 | 30,000 | 12,800 | 12,800 | 5,000 | 12,800 | 12,800 | 12,800 | 12,800 |
| molecular weight | | | | | | | | | | |
| Acid value (mgKOH/g) | 101 | 101 | 101 | 50 | 150 | 150 | 101 | 101 | 101 | 101 |

St: styrene
BzA: benzyl acrylate
BzMA: benzyl methacrylate
PhEA: phenoxyethyl acrylate
nBA: n-butyl acrylate
AA: acrylic acid
A-SA: 2-acryloyloxyethyl succinate (manufactured by Shin-Nakamura Chemical Co., Ltd.)
V-59: 2,2′-azobis(2-methylbutyronitrile)

TABLE 2-2

| Second water-soluble polymer | | B11 | B12 | B13 | B14 | B15 | B16 |
|---|---|---|---|---|---|---|---|
| Monomer (parts) | St | 35 | 35 | 35 | 35 | | 35 |
| | nBA | 52 | 52 | 59 | 45 | 87 | 65 |
| | AA | 13 | 13 | 6 | 20 | 13 | |
| Polymerization initiator (part(s)) | V-59 | 4.0 | 0.6 | 1.5 | 1.5 | 1.5 | 1.5 |

| | | | | | | |
|---|---|---|---|---|---|---|
| Weight-average molecular weight | 4,800 | 32,000 | 12,800 | 12,800 | 12,800 | 12,800 |
| Acid value (mgKOH/g) | 101 | 101 | 45 | 155 | 101 | 0 |

St: styrene
nBA: n-butyl acrylate
AA: acrylic acid
V-59: 2,2'-azobis(2-methylbutyronitrile)

Preparation of Polymer Particles E1 and E3 to E7

A flask equipped with a stirrer, a nitrogen inlet tube, a reflux condenser, and a thermometer was loaded with a mixed liquid of 2 parts of an emulsifier (trade name: “LATEMUL E-150”, manufactured by Kao Corporation) and 20 parts of ion-exchanged water, and then the mixed liquid was heated to 90° C. under a nitrogen atmosphere while stirring. Next, a liquid prepared by mixing monomers whose kinds and amounts were shown in Table 3, 1 part of an emulsifier (trade name: “LATEMUL E-150”), and 80 parts of ion-exchanged water using a homogenizer (trade name: “T50D ULTRA-TURRAX”, manufactured by IKA) was added dropwise over 2 hours. Further, a liquid prepared by dissolving 1.0 part of potassium persulfate in 20.0 parts of ion-exchanged water was added dropwise over 2 hours. After 2 hours of stirring, the pH was adjusted and an appropriate amount of ion-exchanged water was added to obtain emulsions containing polymer particles E1 and E3 to E7 and having a pH of 7 and a solid content of 40%. The obtained emulsions were dried, and the acid values were measured for the polymers for forming the polymer particles contained in the emulsions. Table 3 shows the measured acid values, and the volume-average particle sizes of the polymer particles in the emulsions at a pH of 7. In addition, a portion of the obtained emulsions were adjusted to a pH of 9 with a 1N KOH aqueous solution, and the volume-average particle sizes of the polymer particles after a lapse of 1 day and the rates of change therein were measured and calculated. Table 3 shows the results. It should be noted that the volume-average particle sizes of the polymer particles were measured using a dynamic light scattering particle size analyzer (trade name: “Nanotrac UPA EX-150”, manufactured by NIKKISO CO., LTD.).

Preparation of Polymer Particles E2

A flask equipped with a stirrer, a nitrogen inlet tube, a reflux condenser, and a thermometer was loaded with a mixed liquid of 2 parts of an emulsifier (trade name: “LATEMUL E-150”) and 20 parts of ion-exchanged water, and then the mixed liquid was heated to 90° C. under a nitrogen atmosphere while stirring. Next, a liquid prepared by mixing 60 parts of methyl methacrylate, 15 parts of n-butyl methacrylate, 0.75 part of an emulsifier (trade name: “LATEMUL E-150”), and 60 parts of ion-exchanged water using a homogenizer (trade name: “T50D ULTRA-TURRAX”) was added dropwise. It should be noted that the dropwise addition was performed over 1.5 hours. Next, a liquid prepared by mixing 20 parts of methyl methacrylate, 5 parts of methacrylic acid, 0.25 part of an emulsifier (trade name: “LATEMUL E-150”), and 20 parts of ion-exchanged water using a homogenizer (trade name: “T50D ULTRA-TURRAX”) was added dropwise over 30 minutes. After 2 hours of stirring, the pH was adjusted and an appropriate amount of ion-exchanged water was added to obtain an emulsion containing polymer particles E2, and having a pH of 7 and a solid content of 40%. The obtained emulsion was dried, and the acid value was measured for the polymer for forming the polymer particles contained in the emulsion. Table 3 shows the measured acid value, and the volume-average particle size of the polymer particles in the emulsion at a pH of 7. In addition, a portion of the obtained emulsion was adjusted to a pH of 9 with a 1N KOH aqueous solution, and the volume-average particle size of the polymer particles after a lapse of 1 day and the rate of change therein were measured and calculated. Table 3 shows the results.

It should be noted that polymer particles “PN-A” in Table 3 is a nonionic polyethylene emulsion (manufactured by Sanyo Chemical Industries, Ltd.).

TABLE 3

| Polymer particles | | E1 | E2 | E3 | E4 | E5 | E6 | E7 | PN-A |
|---|---|---|---|---|---|---|---|---|---|
| Monomer | MMA | 80 | 80 | 60 | 60 | 60 | 80 | 80 | — |
| (parts) | nBMA | 15 | 15 | 15 | 15 | 15 | 15 | 15 | |
| | St | | | 20 | | | | | |
| | nBA | | | | 20 | | | | |
| | CHA | | | | | 20 | | | |
| | MAA | 5 | 5 | 5 | 5 | 5 | 3 | | |
| | AA | | | | | | 2 | 5 | |
| Volume- | PS_{pH7} | 180 | 175 | 177 | 171 | 182 | 165 | 182 | 110 |
| average | PS_{pH9} | 184 | 210 | 185 | 180 | 183 | 188 | 220 | 115 |
| particle | (PS_{pH9} − | 2 | 20 | 5 | 5 | 1 | 14 | 21 | 5 |
| size (nm) | PS_{pH7})/PS_{pH7} × | | | | | | | | |
| | 100 (%) | | | | | | | | |

| | | | | | | | | |
|---|---|---|---|---|---|---|---|---|
| Acid value (mgKOH/g) | 33 | 33 | 33 | 33 | 33 | 35 | 39 | 0 |

MMA: methyl methacrylate
nBMA: n-butyl methacrylate
St: styrene
nBA: n-butyl acrylate
CHA: cyclohexyl acrylate
MAA: methacrylic acid
AA: acrylic acid

Preparation of Pigment Dispersion

Components were mixed according to the following composition (100 parts in total), and subjected to premixing (10,000 rpm, 60 minutes) using a dispersion/emulsification machine (trade name: “CLEARMIX”, manufactured by M Technique Co., Ltd.). After that, the mixture was subjected to dispersion treatment (treatment pressure: 150 MPa, 10-pass treatment) using a wet type atomizer (trade name: “NanoVater L-AS”, manufactured by YOSHIDA KIKAI CO., LTD.) to obtain a pigment dispersion (pigment content: 20%).

[Composition]

| | |
|---|---|
| Pigment | 20.0 parts |
| Aqueous solution of first water-soluble polymer (25%) | 0.4 part |

Aqueous solution of second water-soluble polymer (25%)
see Tables 4-1 and 4-2
(such amounts that concentrations in inks take values
shown in Tables 4-1 and 4-2.)

| | |
|---|---|
| Triethylene glycol | 10.0 parts |
| Ion-exchanged water | balance |

Preparation of Inks 1 to 49

Components were mixed according to the following composition (100 parts in total), followed by sufficient stirring. Next, the mixtures were subjected to pressure filtration through a membrane filter having a pore size of 1.2 μm (trade name: “HDCII Filter”, manufactured by Pall Corporation) to prepare inks 1 to 49. It should be noted that the ink 42 was not able to be prepared because A15 was not able to be dissolved in water, and the ink 48 was not able to be prepared because B16 was not able to be dissolved in water. Tables 4-1 and 4-2 show the kind of pigment, and the kinds of the first water-soluble polymer, the second water-soluble polymer, and the polymer particles used in each ink, and their concentrations in the ink in terms of pure content. Tables 4-1 and 4-2 also show the ratio of the first water-soluble polymer and ratio of the polymer particles with respect to the concentration of the pigment in the ink. It should be noted that the concentrations of components derived from the pigment dispersion in the ink are as follows: pigment: 2.0%, first water-soluble polymer: 0.01%, second water-soluble polymer: 0.5%, and triethylene glycol: 1.0%.

[Composition]

| Pigment dispersion | 10.0 parts |
|---|---|
| Aqueous solution of first water-soluble polymer (25%) | |
| see Tables 4-1 and 4-2 | |
| (such amounts that concentrations in the inks take values | |
| shown in Tables 4-1 and 4-2 in terms of the total including | |
| the first water-soluble polymer in the pigment dispersant.) | |
| Emulsion (polymer particle concentration: 40%) | |
| see Tables 4-1 and 4-2 | |
| (such amounts that concentrations in the inks take values | |
| shown in Tables 4.) | |
| Glycerin | 5.0 parts |
| Polyethylene glycol (number-average | 5.0 parts |
| molecular weight: 1,000) | |
| Diethylene glycol | 4.0 parts |
| Surfactant | 1.0 part |
| (trade name “Acetylenol E100”, manufactured by Kawaken | |
| Fine Chemicals Co., Ltd.) | |
| Ion-exchanged water | balance |

TABLE 4-1

| | | | | | | | | | Ratio with | |
|---|---|---|---|---|---|---|---|---|---|---|
| | | | First water- | | Second | | | | respect to | |
| | | | soluble | | water- | | | | pigment (%) | |
| | | | polymer | | soluble | | Polymer | | First | Poly- |
| | Pigment | | | Concen- | polymer | | particles | | water- | mer |
| | | Conc. | | tration | | Conc. | | Conc. | soluble | part- |
| | Kind | (%) | Kind | (%) | Kind | (%) | Kind | (%) | polymer | icles |
| Ink1 | P.B.15:3 | 2.0 | A1 | 0.2 | B1 | 0.5 | E1 | 7.0 | 10 | 350 |
| Ink2 | CB | 2.0 | A1 | 0.2 | B1 | 0.5 | E1 | 7.0 | 10 | 350 |
| Ink3 | P.B.15:3 | 2.0 | A2 | 0.2 | B1 | 0.5 | E1 | 7.0 | 10 | 350 |
| Ink4 | P.B.15:3 | 2.0 | A3 | 0.2 | B1 | 0.5 | E1 | 7.0 | 10 | 350 |
| Ink5 | P.B.15:3 | 2.0 | A4 | 0.2 | B1 | 0.5 | E1 | 7.0 | 10 | 350 |
| Ink6 | P.B.15:3 | 2.0 | A5 | 0.2 | B1 | 0.5 | E1 | 7.0 | 10 | 350 |
| Ink7 | P.B.15:3 | 2.0 | A6 | 0.2 | B1 | 0.5 | E1 | 7.0 | 10 | 350 |
| Ink8 | P.B.15:3 | 2.0 | A1 | 0.2 | B2 | 0.5 | E1 | 7.0 | 10 | 350 |
| Ink9 | P.B.15:3 | 2.0 | A1 | 0.2 | B3 | 0.5 | E1 | 7.0 | 10 | 350 |
| Ink10 | P.B.15:3 | 2.0 | A1 | 0.2 | B4 | 0.5 | E1 | 7.0 | 10 | 350 |
| Ink11 | P.B.15:3 | 2.0 | A1 | 0.2 | B5 | 0.5 | E1 | 7.0 | 10 | 350 |
| Ink12 | P.B.15:3 | 2.0 | A1 | 0.2 | B1 | 0.5 | E2 | 7.0 | 10 | 350 |
| Ink13 | P.B.15:3 | 2.0 | A7 | 0.2 | B6 | 0.5 | E1 | 7.0 | 10 | 350 |
| Ink14 | P.B.15:3 | 2.0 | A1 | 0.2 | B1 | 0.25 | E1 | 7.0 | 10 | 350 |
| Ink15 | P.B.15:3 | 2.0 | A1 | 0.2 | B1 | 0.2 | E1 | 7.0 | 10 | 350 |
| Ink16 | P.B.15:3 | 2.0 | A1 | 0.01 | B1 | 0.5 | E1 | 7.0 | 0.5 | 350 |
| Ink17 | P.B.15:3 | 2.0 | A1 | 0.02 | B1 | 0.5 | E1 | 7.0 | 1 | 350 |
| Ink18 | P.B.15:3 | 2.0 | A1 | 0.30 | B1 | 0.5 | E1 | 7.0 | 15 | 350 |
| Ink19 | P.B.15:3 | 2.0 | A1 | 0.31 | B1 | 0.5 | E1 | 7.0 | 15.5 | 350 |
| Ink20 | P.B.15:3 | 2.0 | A1 | 0.2 | B1 | 0.5 | E1 | 0.9 | 10 | 45 |
| Ink21 | P.B.15:3 | 2.0 | A1 | 0.2 | B1 | 0.5 | E1 | 1.0 | 10 | 50 |
| Ink22 | P.B.15:3 | 2.0 | A1 | 0.2 | B1 | 0.5 | E1 | 10.0 | 10 | 500 |
| Ink23 | P.B.15:3 | 2.0 | A1 | 0.2 | B1 | 0.5 | E1 | 11.0 | 10 | 550 |
| Ink24 | P.B.15:3 | 2.0 | A8 | 0.2 | B1 | 0.5 | E1 | 7.0 | 10 | 350 |
| Ink25 | P.B.15:3 | 2.0 | A1 | 0.2 | B7 | 0.5 | E1 | 7.0 | 10 | 350 |
| Ink26 | P.B.15:3 | 2.0 | A1 | 0.2 | B8 | 0.5 | E1 | 7.0 | 10 | 350 |
| Ink27 | P.B.15:3 | 2.0 | A1 | 0.2 | B9 | 0.5 | E1 | 7.0 | 10 | 350 |
| Ink28 | P.B.15:3 | 2.0 | A1 | 0.2 | B10 | 0.5 | E1 | 7.0 | 10 | 350 |
| Ink29 | P.B.15:3 | 2.0 | A9 | 0.2 | B1 | 0.5 | E1 | 7.0 | 10 | 350 |
| Ink30 | P.B.15:3 | 2.0 | A10 | 0.2 | B1 | 0.5 | E1 | 7.0 | 10 | 350 |
| Ink31 | P.B.15:3 | 2.0 | A1 | 0.2 | B1 | 0.5 | E3 | 7.0 | 10 | 350 |
| Ink32 | P.B.15:3 | 2.0 | A1 | 0.2 | B1 | 0.5 | E4 | 7.0 | 10 | 350 |
| Ink33 | P.B.15:3 | 2.0 | A1 | 0.2 | B1 | 0.5 | E5 | 7.0 | 10 | 350 |
| Ink34 | P.B.15:3 | 2.0 | A1 | 0.2 | B1 | 0.5 | E6 | 7.0 | 10 | 350 |
| Ink35 | P.B.15:3 | 2.0 | A1 | 0.2 | B1 | 0.5 | PN-A | 7.0 | 10 | 350 |
| Ink36 | P.B.15:3 | 2.0 | A1 | 0.2 | B1 | 0.5 | E1 | 7.0 | 10 | 350 |
| Ink37 | P.B.15:3 | 2.0 | A1 | 0.2 | B1 | 0.5 | E1 | 7.0 | 10 | 350 |

P.B. 15:3 Pigment Blue 15:3 (trade name: “Hostaperm Blue B2G”, manufactured by Clariant (Japan) K.K.)
CB: carbon black (trade name: “Printex 80”, manufactured by Orion Engineered Carbons)

TABLE 4-2

| | | | | | Second | | | | Ratio with | |
|---|---|---|---|---|---|---|---|---|---|---|
| | | | First water- | | water- | | | | respect to | |
| | | | soluble | | soluble | | Polymer | | pigment (%) | |
| | Pigment | | polymer | | polymer | | particles | | First | Polymer |
| | | Conc. | | Conc. | | Conc. | | Conc. | water-soluble | part- |
| | Kind | (%) | Kind | (%) | Kind | (%) | Kind | (%) | polymer | icles |
| Ink 38 | P.B.15:3 | 2.0 | A11 | 0.2 | B1 | 0.5 | E1 | 7.0 | 10 | 350 |
| Ink 39 | P.B.15:3 | 2.0 | A12 | 0.2 | B1 | 0.5 | E1 | 7.0 | 10 | 350 |
| Ink 40 | P.B.15:3 | 2.0 | A13 | 0.2 | B1 | 0.5 | E1 | 7.0 | 10 | 350 |
| Ink 41 | P.B.15:3 | 2.0 | A14 | 0.2 | B1 | 0.5 | E1 | 7.0 | 10 | 350 |
| Ink 42 | P.B.15:3 | 2.0 | A15 | — | B1 | — | E1 | — | — | — |
| Ink 43 | P.B.15:3 | 2.0 | A1 | 0.2 | B11 | 0.5 | E1 | 7.0 | 10 | 350 |
| Ink 44 | P.B.15:3 | 2.0 | A1 | 0.2 | B12 | 0.5 | E1 | 7.0 | 10 | 350 |
| Ink 45 | P.B.15:3 | 2.0 | A1 | 0.2 | B13 | 0.5 | E1 | 7.0 | 10 | 350 |
| Ink 46 | P.B.15:3 | 2.0 | A1 | 0.2 | B14 | 0.5 | E1 | 7.0 | 10 | 350 |
| Ink 47 | P.B.15:3 | 2.0 | A1 | 0.2 | B15 | 0.5 | E1 | 7.0 | 10 | 350 |
| Ink 48 | P.B.15:3 | 2.0 | A1 | — | B16 | — | E1 | — | — | — |
| Ink 49 | P.B.15:3 | 2.0 | A1 | 0.2 | B1 | 0.5 | E7 | 7.0 | 10 | 350 |

P.B. 15:3 Pigment Blue 15:3 (trade name: “Hostaperm Blue B2G”, manufactured by Clariant (Japan) K.K.)

Preparation of Liquid Compositions 1 to 3

Glutaric acid, citric acid, or calcium nitrate was used as a reactant, and components were mixed according to the following composition (100 parts in total), followed by sufficient stirring. Next, the mixtures were subjected to pressure filtration through a membrane filter having a pore size of 1.2 μm (trade name: “HDCII Filter”) to prepare a liquid composition 1 (reactant: glutaric acid), a liquid composition 2 (reactant: citric acid), and a liquid composition 3 (reactant: calcium nitrate).

[Composition]

| Reactant | 35.0 parts |
|---|---|
| Surfactant | 3.0 parts |
| (trade name “Zonyl FSN-100”, manufactured by DuPont) | |
| Ion-exchanged water | balance |

Recording of Image

### Examples 1 to 37 and Comparative Examples 1 to 12

An ink and a liquid composition were separately loaded into liquid cartridges according to the combination (set) shown in Table 5, and the liquid cartridges were mounted onto an ink jet recording apparatus (trade name: “PIXUS Pro9500”, manufactured by Canon Inc.). It should be noted that the liquid cartridge loaded with the ink was mounted at cyan and red positions, and the liquid cartridge loaded with the liquid composition was mounted at a photo magenta position. The liquid composition was applied onto a recording medium (trade name: “OK Top Coat”, manufactured by Oji Paper Co., Ltd.) at a recording duty of 50%. Next, the ink was applied so that the inks from the respective cyan and red positions each having a recording duty of 100% overlapped with each other to provide a solid image having a total recording duty of 200%, to thereby perform image recording, and then the image was stored at ordinary temperature for 24 hours. It should be noted that recording conditions were set to a temperature of 23° C. and a relative humidity of 55%. In addition, in the ink jet recording apparatus used, a condition in which 8 dots of 3.5-ng ink droplets are applied at a resolution of 600 dpi×600 dpi in a unit region of 1/600 inch× 1/600 inch is defined as a recording duty of 100%.

Evaluation: Distortion on Image

Distortion on the recorded image was visually observed, and the distortion on the image was evaluated according to the evaluation criteria shown below. It should be noted that in the evaluation criteria shown below, “A” and “B” were defined as preferred levels, and “C” and “D” were defined as unacceptable levels. Table 5 shows the evaluation results.

A: No distortion can be found on the image.
B: Partial distortion can be found on the image, but no problem arises in actual use.
C: Distortion can be found across the entire image.
D: No image was able to be recorded.

TABLE 5

| | Kind | Kind of | |
|---|---|---|---|
| | of | liquid | |
| | ink | composition | Evaluation |
| Example 1 | 1 | 1 | A |
| Example 2 | 2 | 1 | A |
| Example 3 | 3 | 1 | A |
| Example 4 | 4 | 1 | A |
| Example 5 | 5 | 1 | A |
| Example 6 | 6 | 1 | A |
| Example 7 | 7 | 1 | A |
| Example 8 | 8 | 1 | A |
| Example 9 | 9 | 1 | A |
| Example 10 | 10 | 1 | A |
| Example 11 | 11 | 1 | A |
| Example 12 | 12 | 1 | A |
| Example 13 | 13 | 1 | B |
| Example 14 | 14 | 1 | A |
| Example 15 | 15 | 1 | B |
| Example 16 | 16 | 1 | B |
| Example 17 | 17 | 1 | A |
| Example 18 | 18 | 1 | A |
| Example 19 | 19 | 1 | B |
| Example 20 | 20 | 1 | B |
| Example 21 | 21 | 1 | A |
| Example 22 | 22 | 1 | A |
| Example 23 | 23 | 1 | B |
| Example 24 | 24 | 1 | B |
| Example 25 | 25 | 1 | B |
| Example 26 | 26 | 1 | A |
| Example 27 | 27 | 1 | A |
| Example 28 | 28 | 1 | B |
| Example 29 | 29 | 1 | B |
| Example 30 | 30 | 1 | B |
| Example 31 | 31 | 1 | A |
| Example 32 | 32 | 1 | A |
| Example 33 | 33 | 1 | A |
| Example 34 | 34 | 1 | B |
| Example 35 | 35 | 1 | B |
| Example 36 | 36 | 2 | A |
| Example 37 | 37 | 3 | B |
| Comparative | 38 | 1 | C |
| Example 1 | | | |
| Comparative | 39 | 1 | C |
| Example 2 | | | |
| Comparative | 40 | 1 | C |
| Example 3 | | | |
| Comparative | 41 | 1 | C |
| Example 4 | | | |
| Comparative | 42 | 1 | D |
| Example 5 | | | |
| Comparative | 43 | 1 | C |
| Example 6 | | | |
| Comparative | 44 | 1 | C |
| Example 7 | | | |
| Comparative | 45 | 1 | C |
| Example 8 | | | |
| Comparative | 46 | 1 | C |
| Example 9 | | | |
| Comparative | 47 | 1 | D |
| Example 10 | | | |
| Comparative | 48 | 1 | D |
| Example 11 | | | |
| Comparative | 49 | 1 | C |
| Example 12 | | | |

### Comparative Example 13

An image was recorded in the same manner as in “Examples 1 to 37 and Comparative Examples 1 to 12” above except that the ink described in “Example 1” of Japanese Patent Application Laid-Open No. 2003-292838 was loaded into the liquid cartridge, and no liquid composition was used to evaluate distortion on the image. As a result, no image was able to be recorded onto a recording medium, and hence the evaluation result “D” was given. In addition, even when the liquid composition 1 was used in combination, the evaluation result “C” was given.

### Comparative Example 14

An image was recorded in the same manner as in “Examples 1 to 37 and Comparative Examples 1 to 12” above except that “pigment ink 6” described in Examples of Japanese Patent Application Laid-Open No. 2004-115708 was loaded into the liquid cartridge; and no liquid composition was used to evaluate distortion on the image. As a result, no image was able to be recorded onto a recording medium, and hence the evaluation result “D” was given. In addition, even when the liquid composition 1 was used in combination, the evaluation result “C” was given.

### Comparative Example 15

An image was recorded in the same manner as in “Examples 1 to 37 and Comparative Examples 1 to 12” above except that the ink described in “Example 1” of Japanese Patent Application Laid-Open No. 2001-234097 was loaded into the liquid cartridge, and no liquid composition was used to evaluate distortion on the image. As a result, no image was able to be recorded onto a recording medium, and hence the evaluation result “D” was given. In addition, even when the liquid composition 1 was used in combination, a “C” evaluation was given.

### Comparative Example 16

An image was recorded in the same manner as in “Examples 1 to 37 and Comparative Examples 1 to 12” above except that “yellow ink Y3” described in Examples of Japanese Patent Translation Publication No. 2011-508806 was loaded into the liquid cartridge; and no liquid composition was used to evaluate distortion on the image. As a result, no image was able to be recorded onto a recording medium, and hence the evaluation result “D” was given. In addition, even when the liquid composition 1 was used in combination, the evaluation result “C” was given.

### Comparative Example 17

An image was recorded in the same manner as in “Examples 1 to 37 and Comparative Examples 1 to 12” above except that the ink described in “Example 1” of Japanese Patent Application Laid-Open No. 2007-99913 was loaded into the liquid cartridge, and no liquid composition was used to evaluate distortion on the image. As a result, no image was able to be recorded onto a recording medium, and hence the evaluation result “D” was given. In addition, even when the liquid composition 1 was used in combination, the evaluation result “C” was given.

### Comparative Example 18

An image was recorded in the same manner as in “Examples 1 to 37 and Comparative Examples 1 to 12” above except that the “white ink 4” described in “Example 4” of Japanese Patent Application Laid-Open No. 2008-195767 was loaded into the liquid cartridge, and no liquid composition was used to evaluate distortion on the image. As a result, printing was not able to be performed, and hence a “D” evaluation was given.

### Comparative Example 19

An image was recorded in the same manner as in “Examples 1 to 37 and Comparative Examples 1 to 12” above except that “cyan ink C-1” and “treatment liquid” described in “Example 1” of Japanese Patent Application Laid-Open No. 2010-31267 were each loaded into the liquid cartridge to evaluate distortion on the image. As a result, the evaluation result “C” was given.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-149367, filed Jul. 18, 2013, which is hereby incorporated by reference herein in its entirety.

What is claimed is:

1. An image recording method comprising:
applying an ink onto a recording medium; and
applying a liquid composition that destabilizes a dispersion state of a pigment in the ink onto the recording medium so as to at least partially overlap with a region in which the ink is applied,
wherein:
the ink comprises the pigment, a first water-soluble polymer, a second water-soluble polymer, polymer particles, and water;
the first water-soluble polymer has a weight-average molecular weight of 1,000 or more and 4,000 or less and has an acid value of 150 mgKOH/g or more and 300 mgKOH/g or less;
the second water-soluble polymer has an aromatic group and has a weight-average molecular weight of 5,000 or more and 30,000 or less and an acid value of 50 mgKOH/g or more and 150 mgKOH/g or less; and
the polymer particles satisfy the following relationship:
(PS_{pH9}−PS_{pH7})/PS_{pH7}×100≦20%
where PS_{pH9} is a volume-average particle size of the polymer particles at a pH of 9, and PS_{pH7} is a volume-average particle size of the polymer particles at a pH of 7.

2. An image recording method according to claim 1, wherein a content of the second water-soluble polymer is higher than a content of the first water-soluble polymer.

3. An image recording method according to claim 1, wherein a content (mass %) of the first water-soluble polymer is 1% or more and 15% or less in terms of mass ratio with respect to a content (mass %) of the pigment.

4. An image recording method according to claim 1, wherein a content (mass %) of the polymer particles is 50% or more and 500% or less in terms of mass ratio with respect to a content (mass %) of the pigment.

5. An image recording method according to claim 1, wherein each of the first water-soluble polymer and the second water-soluble polymer comprises a constituent unit derived from at least one of acrylic acid and methacrylic acid.

6. An image recording method according to claim 1, wherein the second water-soluble polymer comprises a constituent unit derived from at least one of styrene, benzyl acrylate, and benzyl methacrylate.

7. An image recording method according to claim 1, wherein the polymer particles are formed of a polymer having an acid value of 50 mgKOH/g or less.

8. An image recording method according to claim 1, wherein the liquid composition comprises an organic acid.
